(19) United States
(12) Patent Application Publication
(10) Pub. No.: US 2018/0035526 A1
(43) Pub. Date: Feb. 1, 2018

(54) METHOD FOR AVOIDING OVERLOAD ON THE BURNER NOZZLE OF A PLASMA TORCH

(71) Applicant: OERLIKON METCO AG, WOHLEN, Wohlen (CH)

(72) Inventor: Ni CHENG, Mellingen (CH)

(73) Assignee: OERLIKON METCO AG, WOHLEN, Wohlen (CH)

(21) Appl. No.: 15/556,911

(22) PCT Filed: Mar. 8, 2016
(86) PCT No.: PCT/EP2016/054924

§ 371 Date: Sep. 8, 2017

(30) Foreign Application Priority Data
Mar. 10, 2015 (DE) 102015002939.8

(51) Int. Cl. H05H 1/34; B23K 10/00

(52) U.S. Cl. CPC H05H 1/34; B23K 10/00; H05H 2001/3494

(57) ABSTRACT

The invention relates to a method for starting a recipe in a plasma torch, the method comprising the following steps:
adjusting of a current to a current nominal value
adjusting of a gas flow to a gas nominal value
   characterized in that when adjusting the gas flow to the gas flow nominal value, the current is adjusted such, that it always is below the current nominal value, so that it does not result in a power hill.

The present invention relates to a control method for plasma torches. In particular, the purpose is to extend the service life of an electrode or of the electrodes of a plasma torch.

Plasma torches or plasma arc torches are known. This kind of torches comprises two electrodes, namely an anode and a cathode. An arc is formed between the electrodes and a plasma forming gas is injected. The arc forming between the electrodes is maintained and heats the gas to very high temperatures and ionizes it.

The electrodes are wear parts in such a plasma torch. The service life is a function of a number of parameters, for example of the power of the torch, the nature of the injected plasma forming gas due to its degradation and the reactions it can have with the material forming the electrodes. The service life of the electrodes is also a function of the operation of the torch, depending on whether the torch is operated in a continuous or discontinuous way.

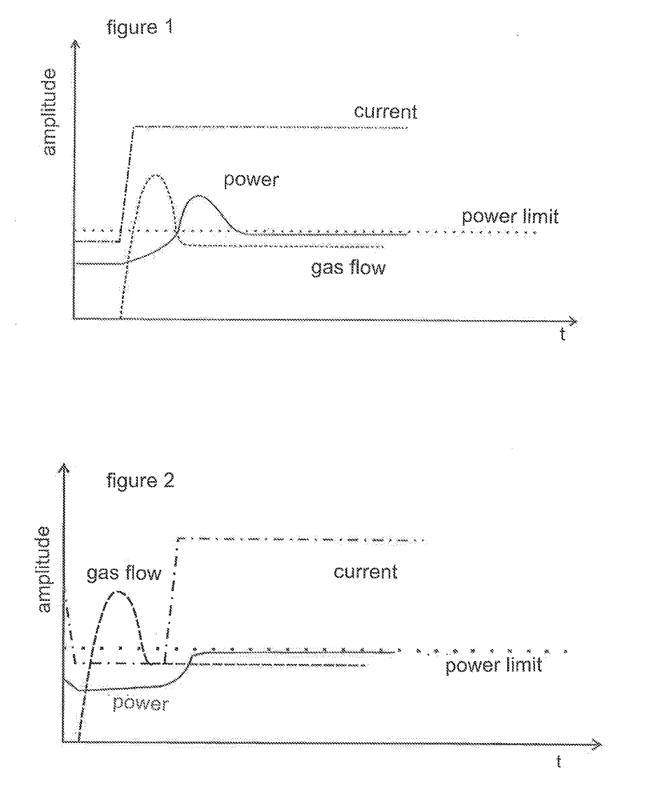

According to the state of the art, the current and the process gas are changed at the same time when starting the plasma process and/or when changing the recipe, wherein the current reaching its set point faster than the gas flow, of course. Initially, the gas flow is often set to a maximum and then re-adjusted to the set point in order to realize an accelerated adjusting of the gas flow and thus reaching the set point faster. As a result, combined with the fact, that the current reaches its set point very fast, the power will exceed the nominal value for a short time when starting or when changing the recipe, in particular because an excessive gas flow exists for a short time after the current set point has already been reached, the gas flow is then re-adjusted. On the one hand, exceeding the nominal value in such a way results in a shorter service life of the electrodes and thus of the torch and, on the other hand it results in an increased power consumption. The graph in FIG. 1 shows such a process. It is obvious, that the power (solid line) exceeds the power limit (dotted line) for a certain time.

Of course, it would be possible to extend the ramp of the gas-adjusting in time for minimizing the undesired power hill. In this case the sequence for the start or the recipe change is delayed in time resulting in an increased gas or power consumption again. In addition, the power hill cannot be completely avoided in this way.

Thus, it is an object of the present invention to propose a process that does not result in the undesired power hill.

According to the present invention, this object is met by maintaining the current at a low level before and also during the gas-adjusting. The current is adjusted to its set point only after the gas flow is adjusted and stable. FIG. 2 shows the corresponding process according to the invention in a graph. An amplitude is drawn depending on time. The dashed line schematically shows the gas flow. The dashed-dotted line schematically shows the current. The dotted line indicates the nominal value of the power, i.e. the power limit. The solid line indicates the actual power. It is clearly visible, that this does not result in a power hill.

The method according to the invention ensures, that at any time the power is lower than or equal to the predetermined nominal power when starting or when changing the recipe.

A method for starting a recipe in a plasma torch was disclosed, the method comprising the following steps:
adjusting of a current to a current nominal value
adjusting of a gas flow to a gas nominal value

The method according to the invention is characterized by the fact, that when adjusting the gas flow to the gas flow nominal value, the current is adjusted in such a way, that it is below the current nominal value at any time such, that it does not result in a power hill.

According to an embodiment of the present invention, the current can be maintained at a substantially constant value below the current nominal value when adjusting the gas flow to the gas flow nominal value and the current can be adjusted to the current nominal value only after stabilizing the gas flow.

The method can be a recipe change. Then the current is preferably maintained at such a high level, so that the plasma does not extinguish.

1. Method for starting a recipe in a plasma torch, the method comprising the following steps:
adjusting of a current to a current nominal value
adjusting of a gas flow to a gas nominal value
characterized in that when adjusting the gas flow to the gas flow nominal value, the current is adjusted such, that it always is below the current nominal value, so that it does not result in a power hill.

2. Method according to claim 1, characterized in that the current is maintained at a substantially constant value below the current nominal value when adjusting the gas flow to the gas flow nominal value and time current is adjusted to the current nominal value only after stabilizing the gas flow.

3. Method according to claim 1, characterized in that the method is a recipe change and that the current is preferably maintained at such a high level, so that the plasma does not extinguish.
